(19) United States
(12) Patent Application Publication
(10) Pub. No.: US 2009/0194742 A1
(43) Pub. Date: Aug. 6, 2009

(54) Reforming system for methanol and method thereof

(76) Inventors: Ryan Yeh, Taipei City (TW); Yen-Ming Chen, Taipei Hsien (TW); Chun-Hsien Wu, Sinjhuang City (TW); Chung-Ming Lin, Taoyuan City (TW); Yu-Cheng Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,136

(22) Filed: Feb. 4, 2008

(51) Int. Cl. C01B 3/38; B01J 19/24

(52) U.S. Cl. 252/373; 422/187

(57) ABSTRACT

A reforming system for methanol comprises a reactor and a fuel unit disposed in front of the reactor. The reactor comprises an inlet, an outlet, a reaction chamber between the inlet and the outlet, and a combustion chamber surrounding the reaction chamber. The reaction chamber has a catalyzing unit thereinside. The reactor is constructed for maintaining the reaction chamber at a predetermined temperature so that at least one reactant acts to produce at least one product in the reaction chamber. The fuel unit comprises a first fuel container, a second fuel container, a mixing chamber connected to the first fuel container and the second fuel container, and a nebulizing device connected to the mixing chamber. The reforming system for methanol can produce hydrogen (H₂) and the secondary products are recycled.

### BACKGROUND OF THE INVENTION

1. Field of the Invention

The present invention relates to a reforming system for methanol and method thereof and in particular to a reforming system to produce hydrogen using heat produced by a combustion reaction.

2. Description of Prior Art

With the development of society, the consumption of energy is increasing rapidly. At present, oil plays a very important role in the world economy. However, its price is continuously rising and the reserves are limited. According to oil analysts, an oil crisis may occur in the future and affect many human lives. Thus alternative energy sources are being developed, such as solar power, nuclear power, fuel cell technology, and so on.

However, there are some critical points in the development of the next generation of energy supplies. For example, power generation by wind or water is limited by the supply of suitable land area, and the development of solar power faces problems because of the difficulty of energy transformation. For nuclear power there are safety and environment concerns. Furthermore, the above-mentioned systems incur energy losses during the long-distance transmission of the energy.

On the other hand, the fuel cell is used for transforming chemical energy into electric energy, and the fuel cell has some advantages concerning its usage. The fuel for the cell is usually hydrogen (H₂), methanol (CH₃OH), ethanol, or some other hydrocarbons, and the oxidant is usually oxygen in air. The secondary products are heat, water, and carbon dioxide (CO₂). The fuel cell using hydrogen (H₂) outputs energy with the highest energy density. Therefore, endeavors are on the way to produce hydrogen (H₂) with high efficiency. Therefore, in view of the above, the inventor proposes the present invention to overcome the above problems based on his expert experience and deliberate research.

### SUMMARY OF THE INVENTION

The primary object of the present invention provides a methanol reforming system and method. The invention produces hydrogen (H₂) using the heat of a combustion and a catalyst.

Another aspect of the present invention provides an environment-friendly system to recycle the secondary products.

In order to achieve the above objects, the present invention provides a reforming system for methanol that comprises a reactor and a fuel unit disposed in front of the reactor. The reactor comprises an inlet, an outlet, a reaction chamber between the inlet and the outlet, and a combustion chamber surrounding the reaction chamber. The reaction chamber has a catalyzing unit thereinside. The reactor is constructed for maintaining the reaction chamber at a predetermined temperature so that at least one reactant acts to produce at least one product in the reaction chamber. The fuel unit comprises a first fuel container, a second fuel container, a mixing chamber connected to the first fuel container and to the second fuel container, and a nebulizing device connected to the mixing chamber.

In order to achieve the above objects, the present invention provides a reforming method for methanol. The method is the following: Step (a) is providing a mixed fuel by mixing water (H₂O) and methanol (CH₃OH) at a predetermined ratio in a mixing chamber. Step (b) is nebulizing the mixed fuel via a nebulizing device to form a nebulized fuel, and leading the nebulized fuel into the reactor. Step (c) is leading a first ratio of the nebulized fuel into a combustion chamber of the reactor, and leading a second ratio of the nebulized fuel into a reaction chamber of the reactor. Step (d) is burning the first ratio of the nebulized fuel in the combustion chamber to maintain the temperature of the reaction chamber at a predetermined temperature so that the second ratio of the nebulized fuel in the reaction chamber reacts and produces hydrogen (H₂) and carbon dioxide (CO₂).

In order to better understand the characteristics and technical contents of the present invention, a detailed description thereof is given in the following with reference to the accompanying drawings. However, it should be understood that the drawings and the description are illustrative but not used to limit the scope of the present invention.

### BRIEF DESCRIPTION OF THE DRAWINGS

FIG. 1 is a schematic view showing the reforming system for methanol according to the present invention;

FIG. 2 is an exploded view showing the reforming system for methanol according to the present invention;

FIG. 3 is a side view showing the reforming system for methanol according to the present invention; and

FIG. 4 is a schematic view showing the valving device of the reforming system for methanol according to the present invention.

### DETAILED DESCRIPTION OF THE INVENTION

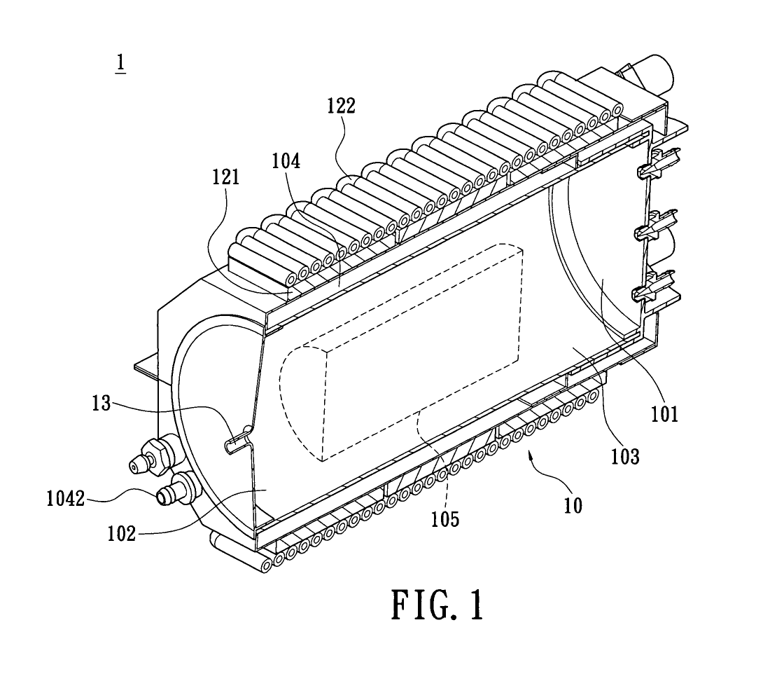

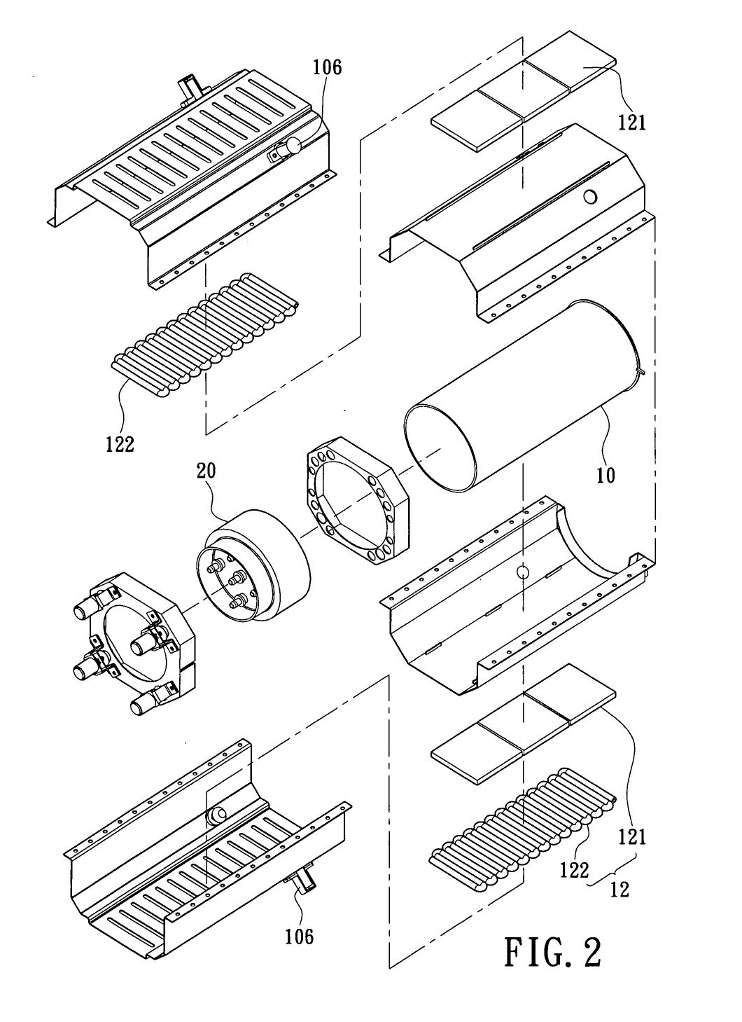

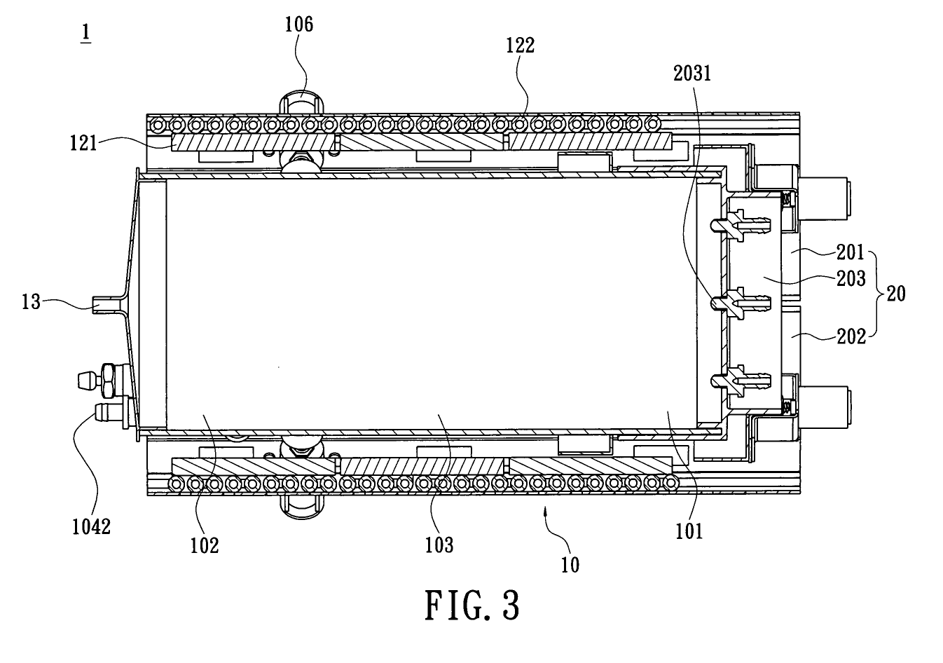

Please refer to FIGS. 1-3, a reforming system for methanol and a reforming method thereof are disclosed. The reforming system for methanol 1 is provided for producing hydrogen (H₂) using a catalytic reaction under the influence of heat produced in a combustion. The catalytic reaction is as follows: CH₃OH+H₂O═CO₂+3H₂. The secondary products are collected and recycled so that the reforming system will not affect the environment.

The reforming system for methanol 1 includes a reactor 10 and a fuel unit 20. The reactor 10 comprises an inlet 101, an outlet 102, a reaction chamber 103 between the inlet 101 and the outlet 102, and a combustion chamber 104 surrounding the reaction chamber 103. The reaction chamber 103 has a catalyzing unit 105 thereinside. The reactor 10 is constructed for maintaining the reaction chamber 103 at a predetermined temperature so that at least one reactant acts to produce at least one product in the reaction chamber 103. The heat produced by the combustion in the combustion chamber 104 provides the energy for the reactant in the catalyzing unit 105 reacting and producing the product.

The fuel unit 20 comprises a first fuel container 201, a second fuel container 202, a mixing chamber 203 connected to the first fuel container 201 and the second fuel container 202, and a nebulizing device 2031 connected to the mixing chamber 203. The nebulizing device 2031 can be a micro bump, or another device that is familiar to a person skilled in the art. The mixed fuel is nebulized by nebulizing device 2031 and the nebulized fuel is guided to the inlet 101 of the reactor 10. The nebulized fuel is simultaneously lead into the reaction chamber 103 and the combustion chamber 104. However, the opening of the reaction chamber 103 is larger than that of the combustion chamber 104, so that only few nebulized fuel flows into the combustion chamber 104.

The first fuel container 201 contains water (H₂O), and the second fuel container 202 contains methanol (CH₃OH). The water (H₂O) and the methanol (CH₃OH) are mixed by a predetermined ratio and then stream reforming reaction is achieved under the influence of heat.

In the embodiment, the first fuel container 201 and the second fuel container 202 connects to the mixing chamber 203 via two pipes with different diameters. The ratio of the diameters of the two pipes is a predetermined value so that water (H₂O) and methanol (CH₃OH) are mixed in a predetermined ratio. The mixing ratio of water (H₂O) and methanol (CH₃OH) is preferably 65:35. The mixed fuel is nebulized by nebulizing device 2031. A fan (not shown) can be disposed in front of the fuel unit 20 and it provides airflow toward the reactor 10. The fan is powered by a chargeable battery (not shown). The nebulized fuel follows the airflow so as to flow to the inlet 101 of the reactor 10.

At the inlet 101, the nebulized fuel separates into a first portion of fuel and a second portion of fuel. The first portion of fuel and the second portion of fuel respectively flow into the combustion chamber 104 and the reaction chamber 103. As above-mentioned, the second portion of the nebulized fuel is larger than the first portion.

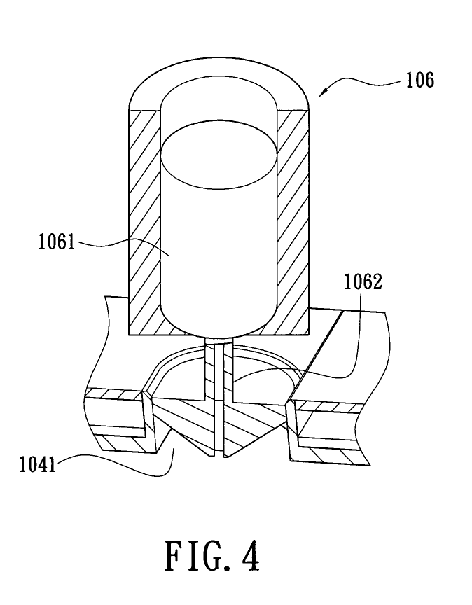

Next, an igniter is used for igniting the first portion of fuel in the combustion chamber 104. The temperature of the reaction chamber 103 increases because of the heat produced in the combustion. When the temperature of the reaction chamber 103 reaches at a predetermined temperature, the second portion of fuel in the reaction chamber 103 reacts and produces hydrogen (H₂) and carbon dioxide (CO₂). The predetermined temperature of the reaction chamber 103 is preferable at 350° C. The catalyzing unit 105 is provided for accelerating the reaction rate. The combustion chamber 104 has at least one hole 1041 (FIG. 4), and a valving device 106 is disposed in each hole 1041. The valving device 106 comprises a micro motor 1061, a valve 1062, and a micro processing unit (not shown), and the valving device 106 is provided for controlling an opening size of the hole 1041 depending on the temperature of the combustion chamber 104. The micro motor 1061 moves the valve 1062 upwardly or downwardly for adjusting the amount of air that flows into the combustion chamber 104 so that the combustion and the temperature of the combustion chamber 104 are further controlled.

Moreover, the heat produced by the combustion can be recycled for generating electric power. A heat recycling unit 12 disposed on an exterior surface of the combustion chamber 104, and the heat recycling unit 12 has a plurality of semiconductor chips 121 and a plurality of cooling pipes 122 disposed on the semiconductor chips 121. The semiconductor chips 121 can be made, for example from BiSb alloys. Electric power is generated by the BiSb alloys because of the temperature deference between the upper surface and the lower surface of the BiSb material. The semiconductor chips 121 are disposed on the combustion chamber 104 and the cooling pipes 122 are disposed on the semiconductor chips 121. In other words, the lower surface of the semiconductor chip 121 is heated by the combustion in the combustion chamber 104 and the upper surface of the semiconductor chip 121 is cooled by the cooling pipes 122. Thus, there is a temperature difference between the upper surface and the lower surface of the semiconductor chip 121 so as to generate electric power. The generated power is preferably used for charging the chargeable battery for the fan. In the embodiment, the number of the semiconductor chips 121 is 12 and there are 4 semiconductor units that have 3 pieces of the semiconductor chips 121 disposed around the combustion chamber 104.

At least one exit 1042 connects to the other side of the combustion chamber 104 for exhausting the water (H₂O) and carbon dioxide (CO₂) produced in the combustion reaction. A collecting unit (not shown) is connected to the exit 1042. The collecting unit includes a gas diffusion layer (GDL) for separating water (H₂O) and carbon dioxide (CO₂) and an absorbing portion for absorbing carbon dioxide (CO₂). The absorbing portion has some sodium hydroxide (NaOH) particles thereinside for absorbing carbon dioxide (CO₂). Therefore, the gas diffusion layer is used for separating the water (H₂O) and carbon dioxide (CO₂) and then the sodium hydroxide (NaOH) particles are used for absorbing carbon dioxide (CO₂). The collected steam can be recycled by condensing it into water. In other words, the products of the combustion are recycled by the system and do not affect the outer environment. Furthermore, the interior surface of the combustion chamber is high heat resistance for resisting the high temperature of the combustion. A shield covers the reforming system for methanol 1 and the shield preferably is a casing and has a vacuum therein for isolating the heat form the environment. Moreover, the interior surface of the casing is coated by a silver layer for reducing the heat radiation.

As a result, the temperature of the reaction chamber 103 reaches the critical parameters so that the second portion of fuel reacts and produces hydrogen (H₂) and carbon dioxide (CO₂) in the catalysis of the catalyzing unit 105. The produced hydrogen (H₂) and carbon dioxide (CO₂) are guided to the outlet 102 of the reactor 10. An absorbing device 13 is connected to the outlet 102 of the reactor 10 for absorbing carbon dioxide (CO₂), and the absorbing device 13 has sodium hydroxide (NaOH) particles thereinside. The produced hydrogen (H₂) passes through the absorbing device 13, but simultaneously the produced carbon dioxide (CO₂) is grabbed by the absorbing device 13, so that pure hydrogen (H₂) are produced. Moreover, there is a vacuum system connected to the absorbing device 13 so that the hydrogen (H₂) is efficiently evacuated out from the reactor 10.

The reforming method for methanol is disclosed as follows: Step (a) is providing a mixed fuel by mixing water (H₂O) and methanol (CH₃OH) at a predetermined ratio in a mixing chamber 203. The water (H₂O) is received in the first fuel container 20, and the methanol (CH₃OH) is received in the second fuel container 202. Step (b) is nebulizing the mixed fuel via a nebulizing device 2031 to form a nebulized fuel, and leading the nebulized fuel into the reactor 10. Step (c) is leading a first ratio of the nebulized fuel into a combustion chamber 104 of the reactor 10, and leading a second ratio of the nebulized fuel into a reaction chamber 103 of the reactor 10. The reaction chamber 103 has a catalyzing unit 105 thereinside and the catalyzing unit 105 provides catalysis to the reforming reaction. Step (d) is burning the first ratio of the nebulized fuel in the combustion chamber 104 to maintaining a temperature of reaction chamber 103 at a predetermined temperature so that the second ratio of the nebulized fuel in the reaction chamber 103 reacts and produces hydrogen (H₂) and carbon dioxide (CO₂). The predetermined ratio of the water (H₂O) and the methanol (CH₃OH) is 65:35 in step (a), and the preferable burning temperature is 350° C. The first portion of fuel reacts and produces water (H₂O) and carbon dioxide (CO₂) in the combustion chamber 104 and the produced water (H₂O) and carbon dioxide (CO₂) are exhausted by the exit 1042 connected to the combustion chamber 104. A gas diffusion layer (GDL) is used for separating water (H₂O) and carbon dioxide (CO₂) and an absorbing portion absorbs the carbon dioxide (CO₂).

After step (d), the produced hydrogen (H₂) and carbon dioxide (CO₂) flow to the outlet 102 and the carbon dioxide (CO₂) is absorbed by the absorbing device 13 so that the hydrogen (H₂) is efficiently separated.

Therefore, the reforming system for methanol 1 and the reforming method for methanol are suitable for producing hydrogen (H₂).

To sum up, the present invention has the following advantages:
1. The second portion of the nebulized fuel is provided for a combustion reaction so that the heat of the combustion reaction can be used to heat the reaction chamber so as to induce the main reaction. The valving device 106 controls the airflow into the combustion chamber 104 so as to control the combustion.
2. The first fuel container 201 and the second fuel container 202 are detachably disposed in the system, so that the first fuel container 201 and the second fuel container 202 can be directly replaced when the fuel expands.
3. The system is friendly for environment because the secondary products such as heat, water are recycled.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. A reforming system for methanol, comprising:
a reactor having an inlet, an outlet, a reaction chamber between the inlet and the outlet, and a combustion chamber surrounding the reaction chamber, wherein the reaction chamber has a catalyzing unit thereinside, the reactor is constructed for maintaining the reaction chamber at a predetermined temperature so that at least one reactant acts to produce at least one product in the reaction chamber; and
a fuel unit having a first fuel container, a second fuel container, a mixing chamber connected to the first fuel container and the second fuel container, and a nebulizing device connected to the mixing chamber, wherein the fuel unit is constructed in front of the reactor to produce nebulized fuel and the nebulized fuel is guided to the inlet of the reactor.

2. The reforming system for methanol according to claim 1, wherein a side of the combustion chamber is connected with the inlet of the reactor, a first ratio of the nebulized fuel is used for a combustion reaction in the combustion chamber, a second ratio of the nebulized fuel is used for the main reaction in the reaction chamber, wherein the heat produced by the combustion reaction is provided for maintaining the reaction chamber in the predetermined temperature.

3. The reforming system for methanol according to claim 2, wherein the combustion chamber has at least one exit at another end thereof for exhausting water (H₂O) and carbon dioxide (CO₂) produced by the combustion reaction.

4. The reforming system for methanol according to claim 3, further comprising at least one collecting unit connected to the exit, wherein the collecting unit includes a gas diffusion layer (GDL) for separating water (H₂O) and carbon dioxide (CO₂) and an absorbing portion for absorbing carbon dioxide (CO₂).

5. The reforming system for methanol according to claim 4, wherein the combustion chamber further has at least one hole, and at least one valving device inside the hole.

6. The reforming system for methanol according to claim 5, wherein the valving device comprises a micro motor, a valve, and a micro processing unit, wherein the valving device is provided for controlling an opening size of the hole depending on a temperature of the combustion chamber.

7. The reforming system for methanol according to claim 5, wherein an interior surface of the combustion chamber has high heat resistance.

8. The reforming system for methanol according to claim 2, wherein the first fuel container contains water (H₂O), the second fuel container contains methanol (CH₃OH), the water (H₂O) and the methanol (CH₃OH) are mixed by a predetermined ratio in the mixing chamber.

9. The reforming system for methanol according to claim 2, wherein the combustion chamber further comprises a heat recycling unit disposed on an exterior surface of the combustion chamber, the heat recycling unit has a plurality of semiconductor chips and a cooling pipe disposed on the semiconductor chips.

10. The reforming system for methanol according to claim 2, further comprising a shield for covering the reforming system for methanol.

11. The reforming system for methanol according to claim 2, further comprising an absorbing device connected to the outlet of the reactor for absorbing carbon dioxide (CO₂).

12. A reforming method for methanol, comprising:
(a). providing a mixed fuel by mixing water (H₂O) and methanol (CH₃OH) at a predetermined ratio in a mixing chamber;
(b). nebulizing the mixed fuel via a nebulizing device to form a nebulized fuel, and conducting the nebulized fuel into a reactor;
(c). leading a first ratio of the nebulized fuel into a combustion chamber of the reactor, and leading a second ratio of the nebulized fuel into a reaction chamber of the reactor, wherein the reaction chamber has a catalyzing unit thereinside; and
(d). burning the first ratio of the nebulized fuel in the combustion chamber to maintain the reaction chamber at a predetermined temperature so that the second ratio of the nebulized fuel in the reaction chamber reacts and produces hydrogen (H₂) and carbon dioxide (CO₂).

13. The reforming method for methanol according to claim 12, wherein in step (a), the predetermined ratio of the water (H₂O) and the methanol (CH₃OH) is 65:35.

14. The reforming method for methanol according to claim 12, wherein in step (d), the nebulized fuel in the combustion chamber burns at 350° C.

15. The reforming method for methanol according to claim 12, wherein in step (d), the first ratio of the nebulized fuel burns and produces water (H₂O) and carbon dioxide (CO₂) in the combustion chamber.

16. The reforming method for methanol according to claim 15, further comprising at least one exit connected to the combustion chamber, wherein the water (H₂O) and the carbon dioxide (CO₂) are exhausted via the exit.

17. The reforming method for methanol according to claim 16, further comprising an absorbing portion connected to the exit, wherein the carbon dioxide (CO₂) is absorbed by the absorbing portion.

18. The reforming method for methanol according to claim 12, further comprising an absorbing device connected to an outlet of the reactor, wherein after step (d), the hydrogen (H₂) and carbon dioxide (CO₂) pass through the absorbing device so that the hydrogen (H₂) is separated from the carbon dioxide (CO₂).

19. The reforming method for methanol according to claim 12, further comprising a heat recycling unit disposed on an exterior surface of the burning room, wherein, the heat produced in step (d) is provided for heating the heat recycling unit so as to produce an electric current.
